(19) United States
(12) Patent Application Publication
(10) Pub. No.: US 2012/0250297 A1
(43) Pub. Date: Oct. 4, 2012

(54) Light Assembly

(76) Inventor: John C. Higgins, Houston, TX (US)

(21) Appl. No.: 13/439,727

(22) Filed: Apr. 4, 2012

Related U.S. Application Data
(60) Provisional application No. 61/471,648, filed on Apr. 4, 2011.

(51) Int. Cl. F21V 29/00; F21L 4/02

(52) U.S. Cl. 362/158; 362/184

(57) ABSTRACT

The present application is directed to a light assembly comprising: an outer housing; a power source; a heat sink disposed within the outer housing; and a nonplanar substrate joined to the heat sink and operationally configured to accommodate one or more LED thereon.

### CROSS-REFERENCE TO RELATED APPLICATIONS

This application claims the priority of U.S. Prov. Pat. App. Ser. No. 61/471,648 (filed Apr. 4, 2011).

### STATEMENT REGARDING FEDERALLY SPONSORED RESEARCH OR DEVELOPMENT

Not applicable.

### BACKGROUND OF THE INVENTION

1. Field of the application

The application relates generally to lighting devices, and more particularly to LED-based lighting devices.

2. Background

Most lighting currently in use includes either incandescent light bulbs or fluorescent light bulbs. An incandescent light bulb typically comprises a base, a glass shell, a thin filament which is normally a thin tungsten filament within the shell, and an inert gas within the shell. When an electric current passes through the filament and heats it up to an extremely high temperature (from about 2000° C. to about 3000° C. depending on the filament type, shape, size, and amount of current passed through), heat radiation occurs and visible light is produced. However, the process is considered highly inefficient, as over 98 percent of the energy is emitted as invisible infrared light(or heat). Also, the typical lifespan of an incandescent bulb is limited to about 1,000 hours.

A fluorescent light bulb is filled with gas containing low-pressure mercury vapor and an inert gas such as argon or xenon. Typically, the inner surface of the bulb is coated with a fluorescent coating made of various blends of metallic and rare-earth phosphorus salts. When electricity passes through mercury vapor, the mercury vapor produces ultraviolet light (“UV” light). The ultraviolet light is then absorbed by the phosphorus coating inside the bulb, causing it to glow, or to fluoresce. While the heat generated by fluorescent light is much less than its incandescent counterpart, efficiencies are still lost in generating the ultraviolet light and converting this light into visible light. In addition, fluorescent bulbs are typically more expensive than incandescent bulbs, but have longer life spans up to about 10,000 hours.

Light emitting diodes (“LEDs”) are, in general, miniature semiconductors that employ a form of electroluminescence resulting from the electronic excitation of a semiconductor material, which produces visible light. Typically, LEDs have high durability and a long life span up to about 100,000 hours. The LED generates less heat and less energy loss than incandescent lights and fluorescent lights, thereby reducing the overall electricity used. In addition, LEDs, being solid state devices, require much less space. However, LEDs are subject to thermal damage or destruction at temperatures that are much lower than those tolerated by incandescent bulbs. LEDs are susceptible to damage at temperatures exceeding about 150° C. (about 423°K).

Unlike incandescent and fluorescent lights, LEDs ordinarily produce light in a narrow, well defined beam. In other words, LEDs are directional light emitters. While this is desirable for many applications, the broader area illumination afforded by incandescent and fluorescent lights are also often desired. Currently available devices i incorporate multiple LEDs placed along planar substrates such as ceramic substrates. Unfortunately, the area of illumination is substantially limited to the directional beams of light as emitted from each individual diode (see the exemplary light spread A-A at FIG. 1). In addition, closely spaced LEDs may interfere with each other and result in reduced light output.

Also, ceramic substrates are used because the LEDs have thermal and electrical paths that come in contact with each other. For example, an LED may have electrical contacts on both top and bottom surfaces so that when the LED is mounted to a substrate, both heat and electricity may pass to the substrate. Thus, the ceramic substrate provides electrical insulating properties while allowing some heat to pass. Unfortunately, the ceramic substrate doesn't provide a very efficient thermal path so that heat generated by closely spaced LED chips may degrade light output. To facilitate heat dissipation, the ceramic substrate may be mounted to an aluminum heat spreader, which in turn is mounted to an additional heat sink. Such arrangements are costly and complicated to manufacture.

Accordingly, there is a need in the art for improvements in LED devices to provide broader illumination, increase light output, while providing efficient heat dissipation.

### BRIEF DESCRIPTION OF THE FIGURES

FIG. 1 is a simplified perspective view of a known LED array disposed along a planar substrate and indicating an exemplary breadth of light emitted there from. FIG. 1 is a simplified perspective view of a known LED array disposed along a planar substrate and indicating an exemplary breadth of light emitted there from.

FIG. 2 is a simplified side view of a known LED assembly.

FIG. 3 is an exploded view of an embodiment of the present light assembly.

FIG. 4 is a perspective view of an embodiment of the present light assembly as assembled.

FIG. 5 is a perspective view of an exemplary embodiment 5 of a housing base of the present light assembly.

FIG. 6 is a perspective view of an exemplary substrate including an array of light emitting diodes thereon.

FIG. 7 is a perspective view of an exemplary light assembly including a simplified illustration of light spread of the assembly.

FIG. 8A is a top view of an exemplary LED.

FIG. 8B is a side view of an exemplary LED.

FIG. 8C depicts electrical and optical characteristics for a suitable LED of the present light assembly.

FIG. 9 is a is a perspective view of an exemplary heat sink and substrate including directional heat and air flow during operation of the light assembly of this application.

FIG. 10 is a side view of an exemplary housing base of the light assembly.

FIG. 11 is a detailed view of an exemplary housing base.

FIG. 12 is a top view of an exemplary housing base.

FIG. 13 is a sectional side view of an exemplary housing base.

FIG. 14 is another side view of an exemplary housing base.

FIG. 15 is a bottom view of an exemplary housing base.

FIG. 16 is a sectional side view of an exemplary housing base.

FIG. 17 illustrates a side view of an exemplary power driver.

FIG. 18 is an end view of the power driver of FIG. 17.

FIG. 19 is a top view of an exemplary substrate of the 5 light assembly.

FIG. 20 is a side elevational view of the substrate of FIG. 19.

FIG. 21 is a perspective exploded view of an exemplary substrate and LED array.

FIG. 22 is a top view of an exemplary lense of the light assembly.

FIG. 23 is a side elevational view of the lense of FIG. 22.

FIG. 24 depicts optical and electrical characteristics curves for a light assembly of this application.

FIG. 25 depicts reliability test information for a light assembly of this application.

FIG. 26 depicts the forward voltage of a suitable LED for the light assembly of this application.

FIG. 27 illustrates a C.I.E. 1931 Chromaticity Diagram as related to suitable LED of the present application.

### BRIEF DESCRIPTION

It has been discovered that a non-planar LED substrate may be provided to expand the surface area of light emitted onto a target surface beyond the area of light provided by a planar LED substrate. A non-planar LED substrate is also effective for providing greater heat dissipation beyond that provided by a planar LED substrate constructed from like material(s). Heretofore, such a desirable achievement has not been considered possible, and accordingly, this application measures up to the dignity of patentability and therefore represents a patentable concept.

Before describing the invention in detail, it is to be understood that the present light assembly and method are not limited to particular embodiments. 5 It is also to be understood that the terminology used herein is for the purpose of describing particular embodiments only, and is not intended to be limiting. As used in this specification, the phrase “target surface” refers to a surface to be illuminated by a light source including the light assembly of this application.

In one aspect, the application provides a light assembly including a nonplanar substrate surface with an array of light emitting diodes thereon.

In another aspect, the application provides a light assembly including an array of light emitting diodes affixed to a non-planar surface of a substrate of the light assembly.

In another aspect, the application provides a light assembly having a convex substrate surface including an array of light emitting diodes affixed thereto.

In another aspect, the application provides a light assembly including an array of light emitting diodes affixed to a non-planar surface of a substrate of the light assembly, wherein each LED emits light directionally in a non-parallel relationship to light being emitted from the remaining LEDs of the light assembly.

In another aspect, the application provides a light assembly operationally configured to dissipate heat.

In another aspect, the application provides a light assembly including a substrate for receiving light emitting diodes thereon, the substrate being set apart from a heat sink of the light assembly.

In another aspect, the application provides a light assembly including a heat sink having a plurality of apertures there through.

In another aspect, the application provides a light assembly including an array of light emitting diodes disposed along the outer surface of a non-planar substrate, the light assembly being operationally configured to broaden the area of illumination across a target surface beyond the area of illumination for the same type LEDs when disposed along a planar surface of a substrate.

In another aspect, the application provides a light assembly including an array of light emitting diodes disposed along a non-planar surface, the light assembly being operationally configured to maintain the temperature of each LED below about 40.6° C. (about 105° F.).

In another aspect, the application provides a surface substrate for affixing LEDs, wherein the curvature of the surface substrate may be altered to either lessen or broaden the intended area of illumination upon a target surface.

In another aspect, the application provides a light assembly including a non-planar substrate surface with an array of light emitting diodes thereon, the substrate comprising a reflective surface.

In another aspect, the application provides a light assembly including a planar heat sink operationally configured to dissipate heat received from a non-planar substrate including an LED array thereon.

In another aspect, the application provides a light assembly including a planar heat sink connected to a non-planar substrate for mounting LEDs, wherein the heat sink includes a plurality of apertures operationally configured to allow for air flow in and out of the space between the heat sink and the substrate.

In another aspect, the application provides a light assembly 5 incorporating an LED suitable for one or more of the following applications: high power flood lights, automotive (head lamps, turn signals), high lumen intensity signage, general outdoor and indoor illumination, and special spectrum lighting devices with complex phosphor and epi combination.

### DISCUSSION OF THE DEVICE

To better understand the novelty of the invention, reference is hereafter made to the accompanying drawings. It will be understood that particular embodiments described herein are shown by way of illustration and not as limitations of the invention. However, this inventive subject matter should not be construed as limited to the embodiments set forth herein. The principal features of this invention can be employed in various embodiments without departing from the scope of the invention.

With reference to FIG. 2, an exemplary LED assembly 10 as known in the art is provided. Current LED assemblies and arrays in commercial use typically include one or more of the following: LED die 11, sub-mount 12, substrate 13, enclosure 14, thermal interface material 15, and heat sink 16. As shown, the LED die 11 is typically mounted to the sub-mount 12, wherein the sub-mount 12 has conductive traces and conductive surfaces through which an LED die 11 cathode and anode may be connected. The sub-mount 12 is suitably mounted to a first surface of the substrate 13, such as a circuit board, wherein wires or other electrical connections are bonded between the electrical paths of the substrate and the conductive surfaces of the submount 12. The LED die 11, sub-mount 12, and a portion of the substrate 13 are suitably housed within enclosure 14 operationally configured to (1) preserve the LED assembly 10, and in certain instances (2) provide a lens for beneficial optical dispersion of light. As LEDs radiate energy as heat, some form of thermal interface material 15 operationally configured to transfer heat between two surfaces may be applied to a second surface of the substrate 13. A heat sink 16 or other form of heat dissipating device may also be applied to the free surface of the thermal interface material 15. The light assembly of the present application improves on such known technology by providing advancements in both illumination and heat dissipation.

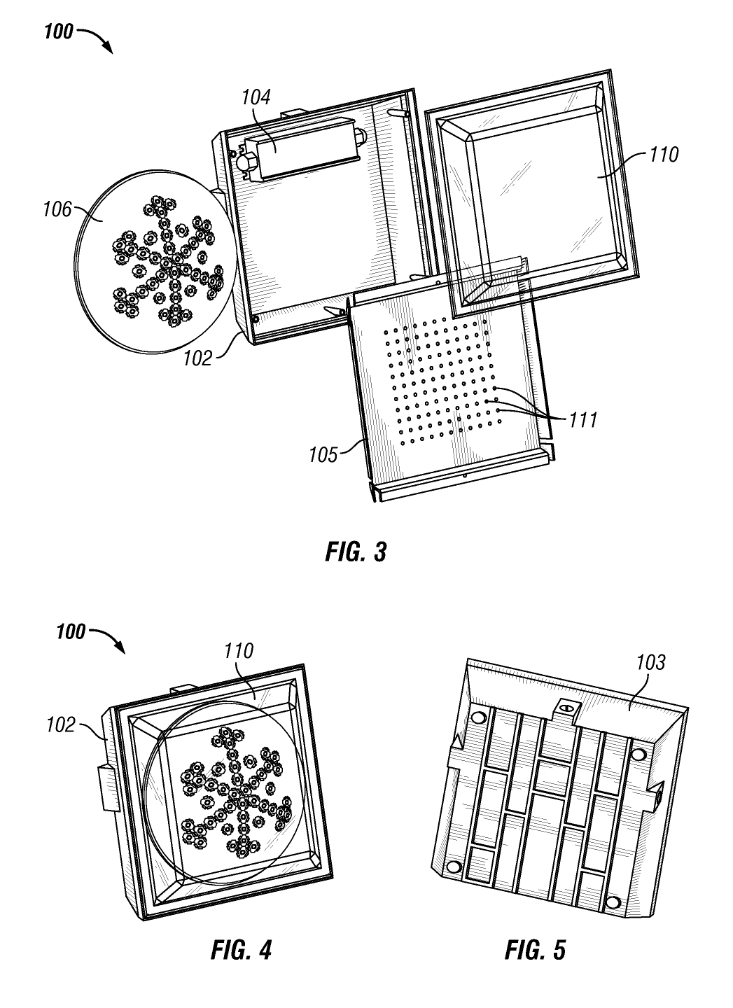

With reference to FIG. 3, the light assembly 100 of this application includes a housing base 102, a power driver 104 attached to the housing 102, a heat sink 105 releasably attachable to the housing base 102, and a non-planar substrate 106 having an array of LEDs 108 disposed thereon, wherein the substrate 106 is suitably releasably attachable to the heat sink 105. As desired, the assembly 100 may also include a lense 110 operationally configured to protect the LED array 108 and alter or enhance light output of the assembly 100. As shown in FIG. 4, the housing base 102 and lense 110 suitably operate to enclose and seal the electrical components of the light assembly 100 during operation.

As FIGS. 3 and 4 illustrate, the housing base 102 suitably includes an inner surface configuration effective to receive the power driver 104 and heat sink 105 therein. Once assembled, the plane of the outer surface of the heat sink 105 suitably runs substantially parallel to the plane of the outer surface of the housing base 102, although it is also contemplated that the housing base 102 may include a non-planar outer surface.

Without limiting the housing base 102 to any particular materials of construction, the housing base 102 is suitably constructed from materials 5 including, but not necessarily limited to those materials resistant to chipping, cracking, excessive bending and reshaping as a result of ozone, weathering, heat, moisture, other outside mechanical and chemical influences, physical impacts, and combinations thereof. In particular, the housing base 102 is suitably constructed from materials including but not necessarily limited to metals, polymeric materials, fiberglass, plexiglass, filled composite materials, and combinations thereof. In one exemplary embodiment, the housing base 102 may be constructed from one or more ultra-violet light stabilized plastic materials including, but not necessarily limited to polycarbonate, polyvinyl chloride (PVC), and combinations thereof. In another exemplary embodiment, the housing base 102 may be constructed from one or metals including, but not necessarily limited to stainless steel or aluminum. It is also contemplated that the housing base 102 may include any desired shape. For example, the housing base 102 may be circular, oval, or multi-sided as shown in FIGS. 3-5.

Suitably, the housing base 102 may include one or more apertures for receiving fastening means such as screws and the like for joining the power driver 104 to the housing base. The housing base 102 may also include apertures for joining the heat sink 105 thereto via one or more fastening means. In another embodiment, the housing base 102 may include an inner surface configuration effective for the power. driver 104 and/or the heat sink 105 to be snap fit to the housing base 102. In one embodiment, the housing base 102 and its sidewalls 103 (see FIG. 5) may be assembled together. In another embodiment, the housing base 102 may be produced as a single unit via injection molding and the like.

With reference to FIG. 3, the heat sink 105 suitably 5 includes a planar member operationally configured to be joined to the housing base 102 as described above. As explained in more detail below, the heat sink 105 suitably includes a plurality of apertures 111 there through, the apertures 111 being effective to (1) allow air flow there through, and (2) the release of heat there through that is generated by the LEDs. Suitable apertures have a diameter or width of about 0.229 mm or less (about 0.009 inches or less). In one embodiment, a suitable heat sink 105 may be constructed from one or more metals. In an alternative embodiment, a suitable heat sink 105 may be constructed from one or more materials having substantially similar strength, thermal and/or other conductivity characteristics as the one or more metals. Suitable heat sink 105 metals include, but are not necessarily limited to brass, copper, aluminum, and combinations thereof. Other suitable heat sink 105 materials may include graphite materials, ceramic materials, and combinations thereof.

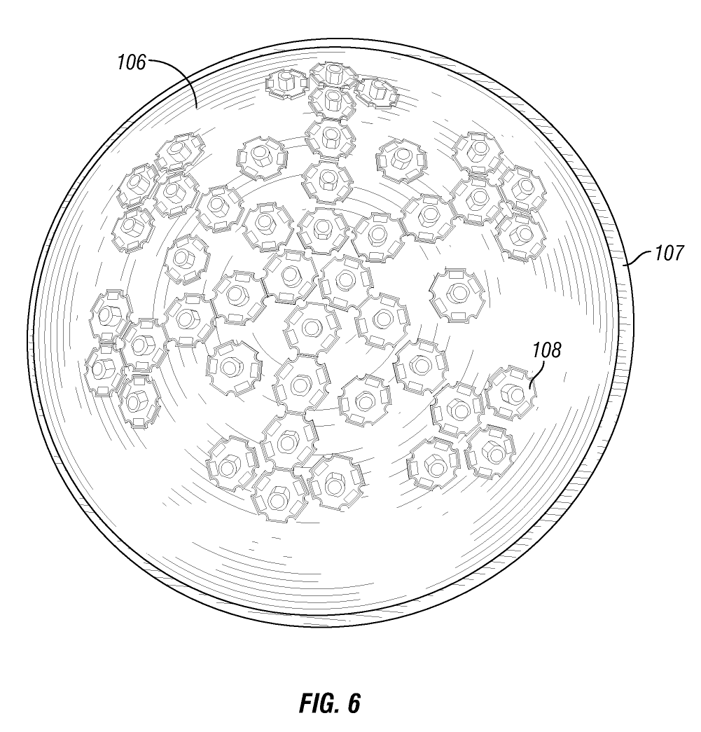

A non-planar substrate 106 of the light assembly 100 may be provided in various forms. For example, the non-planar substrate 106 may include a spherical outer surface, or a convex outer surface as shown in the drawings. It is also contemplated that the non-planar substrate 106 may include other curved outer surfaces as desired. With reference to FIG. 6, a suitable substrate 106 may include a rim 107 along the periphery of the substrate providing an attachment surface for the substrate 106 to the heat sink 105. For example, one or more fastening means may be used to join the substrate 106 to the heat sink 105 at the rim 107. In another embodiment, the substrate 106 may be sealably adhered to the heat sink 105. In another embodiment, the substrate 106 may be fastened to the heat sink 105 as determined by corresponding fastening surfaces of the substrate 106 and heat sink 105. Although the light assembly 100 may be built to scale, for outdoor lighting applications as used to illuminate sections of parking lots, tunnels, and the like, a convex substrate 106 suitably includes an outer diameter at the rim 107 up to about 50.8 cm (about 20.0 inches). In one particularly advantageous embodiment, a convex substrate 106 includes an outer diameter at the rim 107 of about 26.4 cm (about 10.4 inches) and an inner diameter at the substrate 106 base of about 26.0 cm (about 10.25 inches). In this embodiment, the substrate 106 suitably includes a height of about 5.1 cm (about 2.0 inches). In addition, where the convex substrate 106 is constructed from aluminum, the substrate suitably includes a wall thickness up to about 0.16 cm (about 0.063 inches). In an advantageous embodiment, an aluminum convex substrate 106 includes a wall thickness of about 0.08 cm (about 0.030 inches).

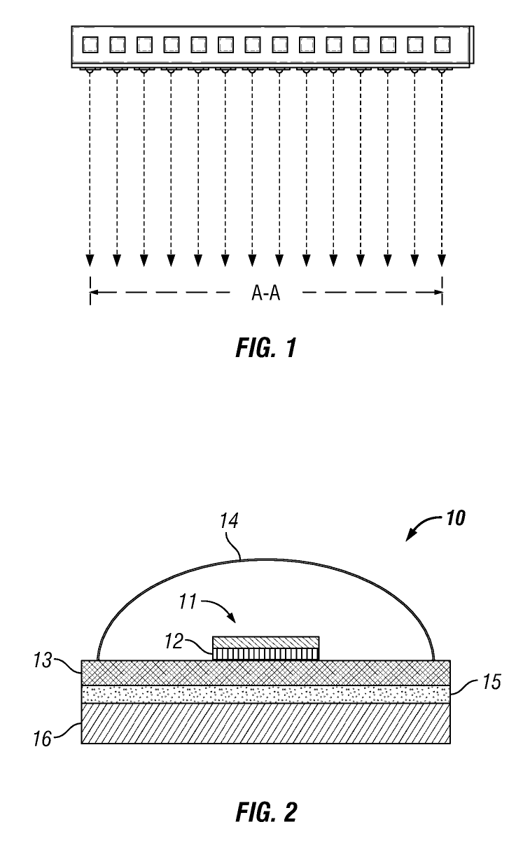

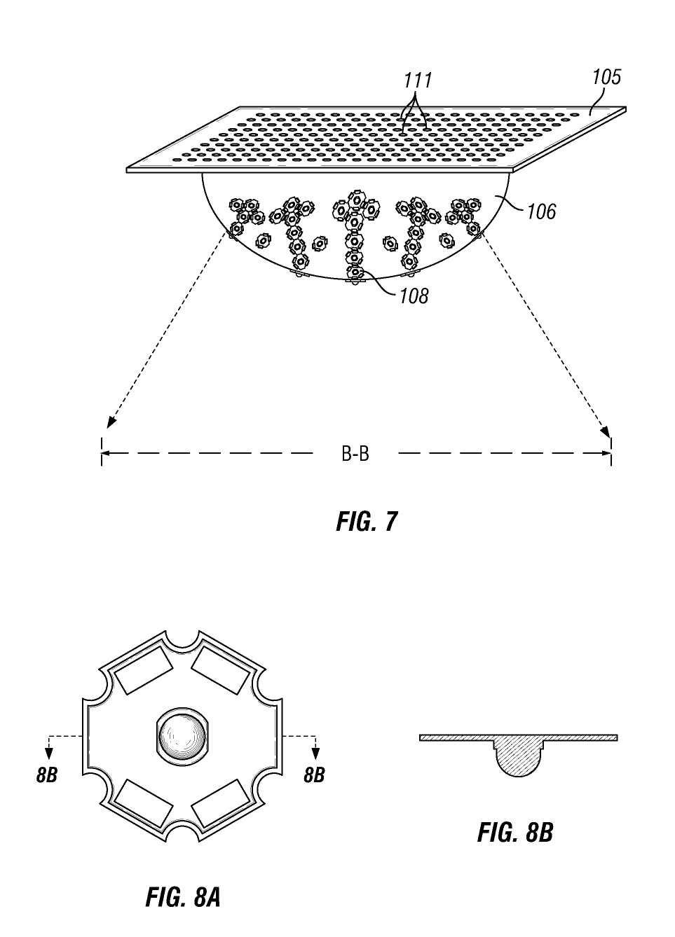

With continued reference to FIG. 6, an array of LEDs 108 are disposed upon the outer surface of the substrate 106 in a manner effective (1) to produce a desired amount of light spread upon a target surface, and/or (2) to provide a desired light intensity to a target surface. Suitably, the LED array 108 is disposed upon the substrate 106 surface in a manner effective for each individual LED to project light directional along a linear path different than the remaining LED of the array 108. In other words, each LED is operationally configured to project light along a directional path substantially perpendicular to the plane of the tangent line located at the point of attachment of each LED to the substrate 106. As shown in FIG. 7, the light spread B-B of an exemplary light assembly 100 extends beyond the perimeter of the heat sink 105 (and corresponding housing base 102) as compared to the light spread of FIG. 1.

In addition, a suitable LED array 108 may be disposed across a metal substrate 106 having a reflective surface. In such embodiment, the metal substrate may include any reflective metal as desired. In one particular embodiment, the metal substrate may be constructed from aluminum including a reflective surface of bare or polished aluminum. Alternatively, the reflective surface may be formed by silver plating on the substrate 106. Therefore, it is contemplated that the surface of substrate 106 may be utilized as a reflective surface depending on the type of light source(s) being applied to the substrate 106 surface.

Suitably, the LED array 108 is in electrical communication with the power driver 104, which is operationally configured to power the array 108. A suitable power driver 104 includes, but is not necessarily limited to a constant current source LED driver (Input 85-227V) as is understood by persons of ordinary skill in the art. In a suitable embodiment, the power driver 104, heat sink 105, and LED array 108 lie in electrical communication by passing electrical pins 420 (having insulated sleeves disposed thereon) of the power driver 104 through apertures 111 in the heat sink 105, and making an electrical connection to the LEDs of LED array 108 in a manner known in the art. Although the LED array 108 may be powered as desired, when applied to a substrate 106 having a convex outer surface, wiring (not shown) is suitably run from the power driver 104 through an aperture at the apex of the substrate 106 to connect to the LED array 108.

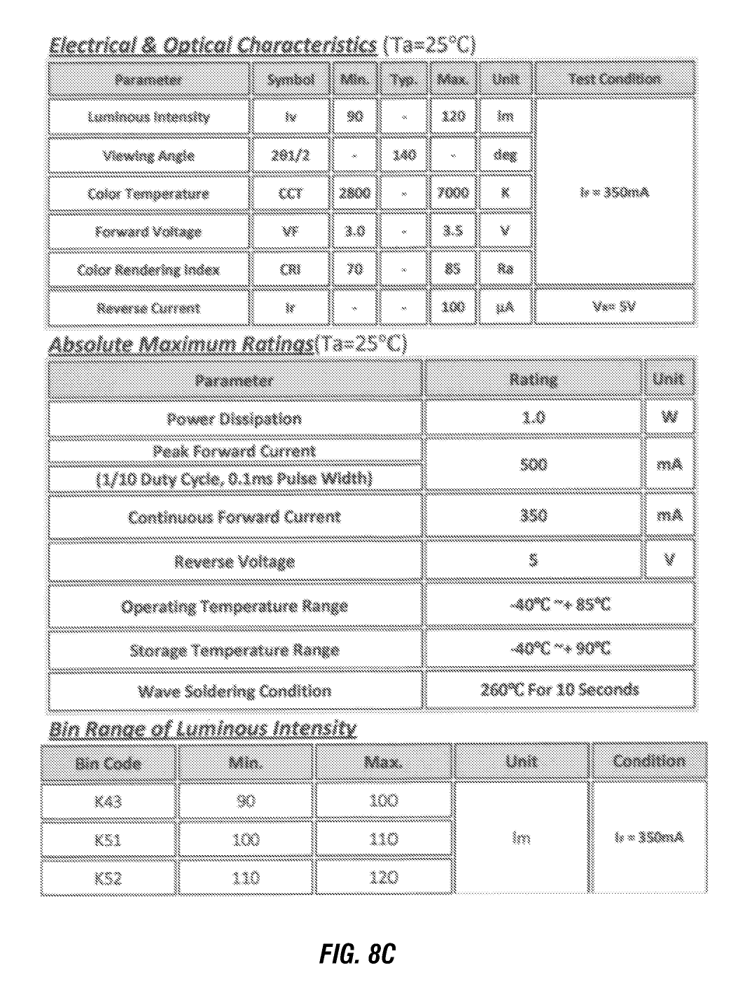

As shown in FIG. 6, the LED array 108 is suitably mounted directly onto the outer surface of the substrate 106. Although various types of LEDs are contemplated for use as part of the present light assembly 100, a suitable type of LED is shown in FIGS. 8A-8B, having performance characteristics as shown in FIG. 8C. Although the light assembly 100 may be built to scale, a suitable LED has the following dimensions for indoor and outdoor applications: 16 mm×11 mm×2.3 mm. In addition, LEDs of this application may provide electromagnetic radiation at wavelengths ranging from about 390 nm to about 750 nm, i.e., the visible light spectrum. It is also contemplated that LEDs operationally configured to emit ultra-violet light (wavelengths below 400 nm) may be employed as desired.

As stated above, since the LEDs have a mounting surface that is separate from the electrical path, the LEDs can be mounted directly onto the surface of the substrate 106. In doing so, an efficient thermal path is formed allowing heat to pass from the array of LEDs 108 to the substrate 106. It should also be noted that there is no limit on the number of LEDs that may be used and in fact, as the number of LEDs increases the optical gain increases. In one embodiment, a particular LED pattern using a predetermined number of LED may define the array 108. Ultimately, the maximum number of LEDs is determined by the surface area of the substrate 106 and the size of LEDs being used.

As desired, the LED array 108 is suitably mounted on the substrate 106 with a pre-determined spacing between adjacent LED. In one simplified example, the LED array 108 may be mounted to the substrate 106 in a manner to include a pattern and spacing as illustrated in FIG. 6. In this embodiment, the spacing between adjacent LEDs is suitably from about 3.0 mm to about 7.0 mm (from about 0.12 inches to about 0.28 inches). When applicable, the spacing there between exposes regions of a reflective surface of the substrate 106 between the LEDs. In such embodiment, by exposing these regions of the substrate 106, light emitted from the LEDs may reflect off the exposed portions of the reflective surface of the substrate 106 to increase the amount of light output from the LED array 108. It should be noted that the LED array 108 may have uniform spacing, non-uniform spacing, or a combination thereof and is not necessary limited to uniform spacing there between.

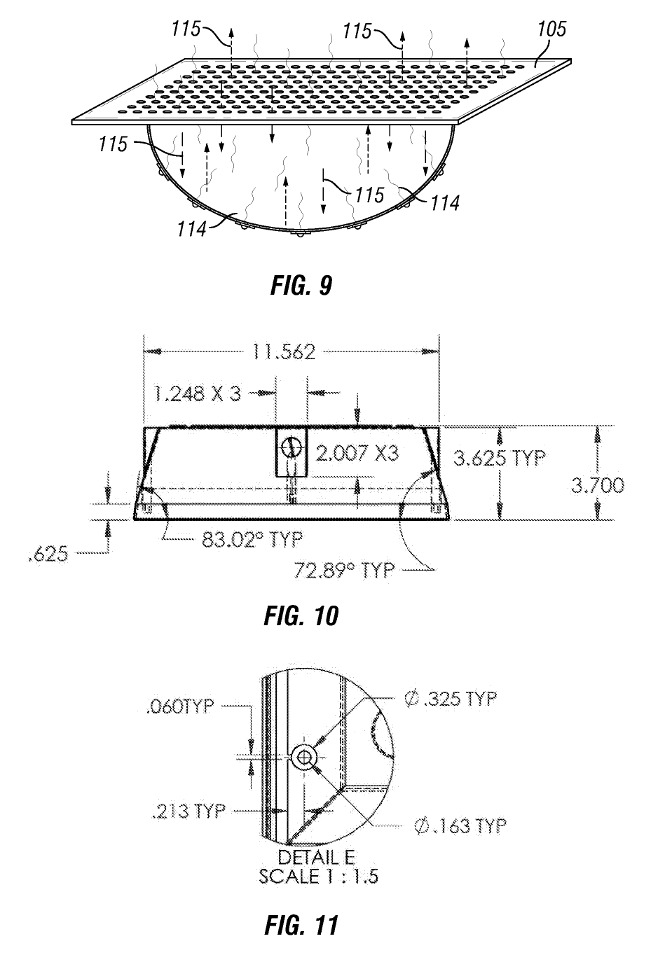

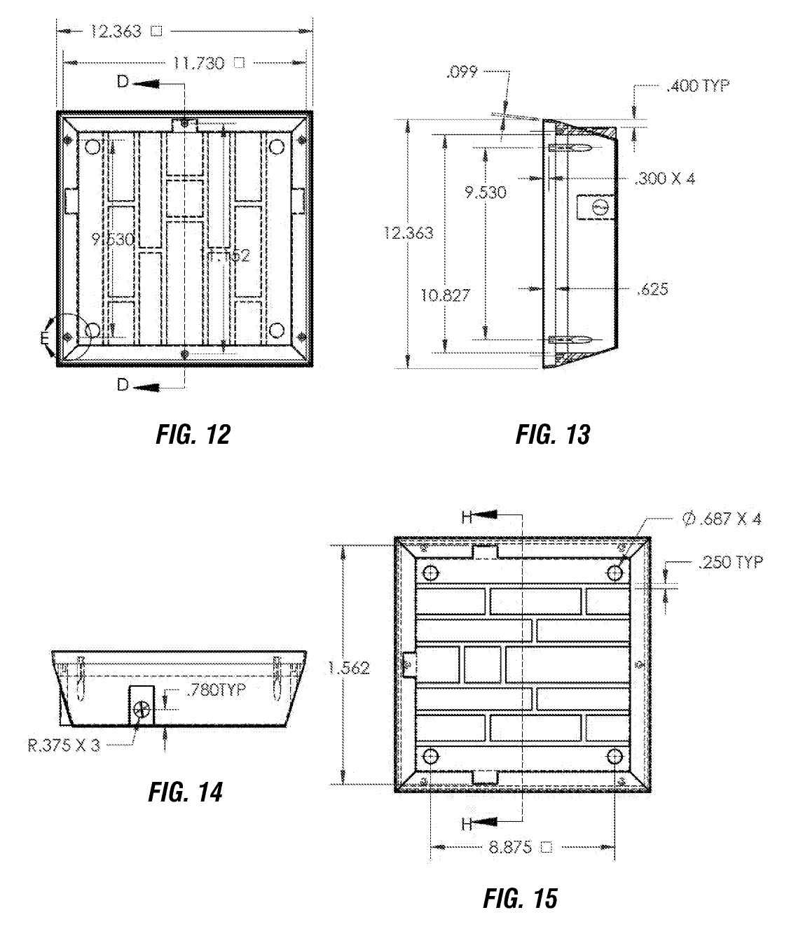

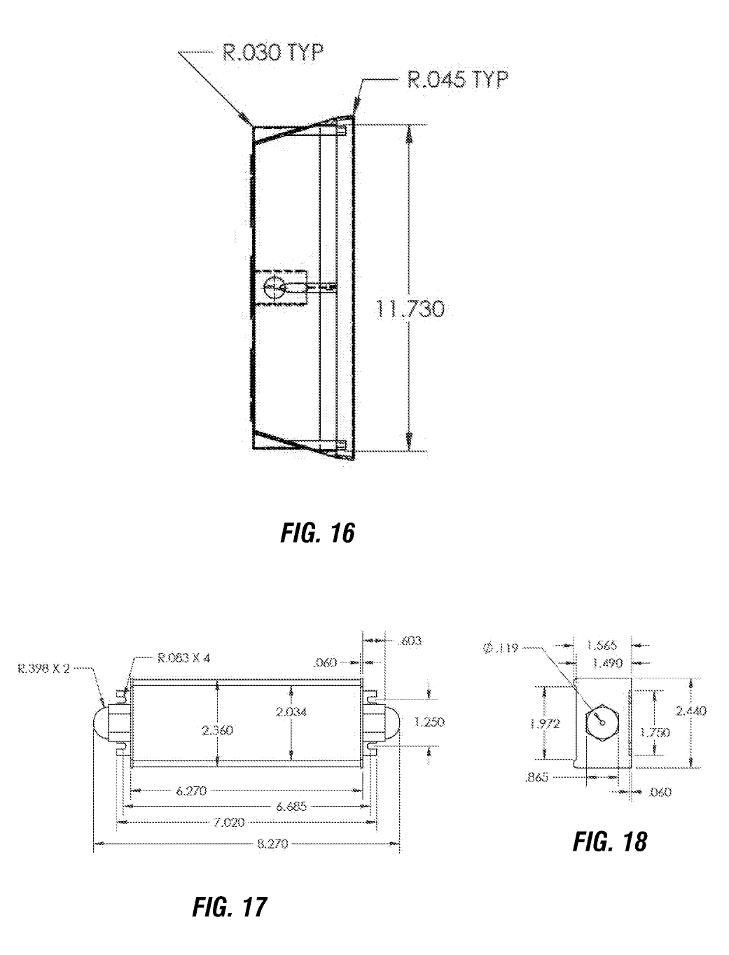

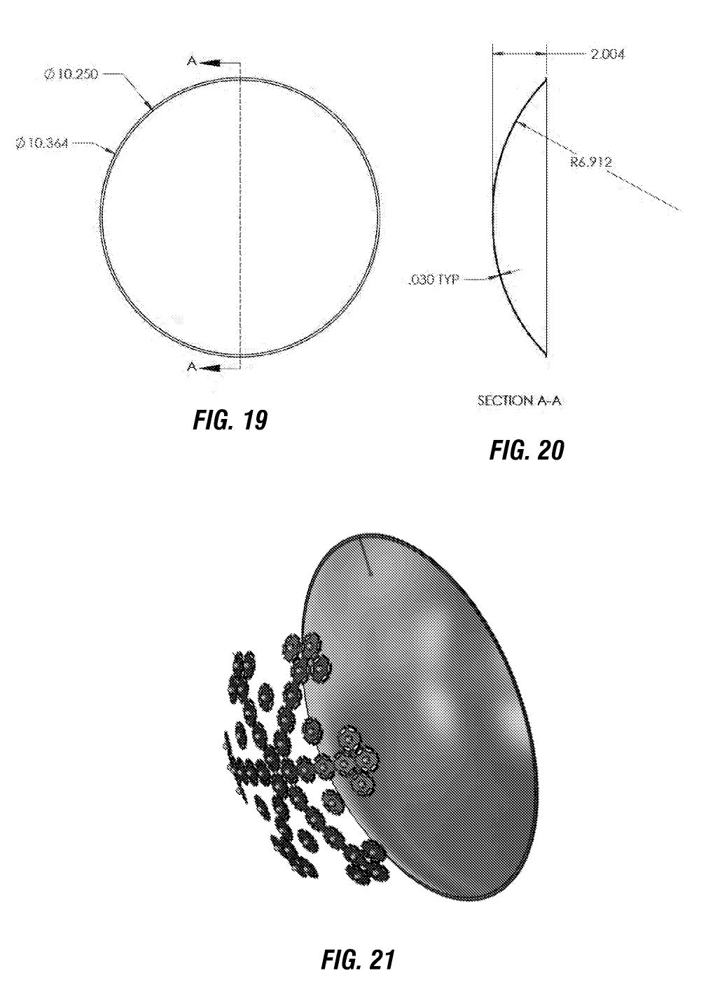

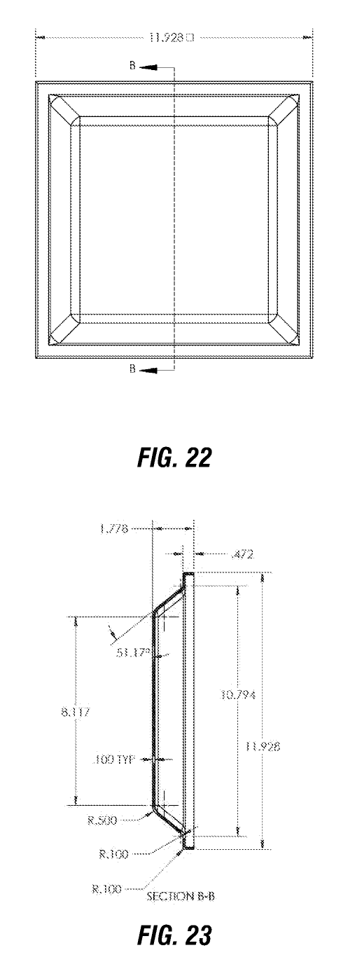

With reference to FIG. 9, during operation of the light assembly 100 heat generated by the LEDs is suitably transferred, at least in part, to the substrate 106 wherein the non-planar shape of the substrate 106 is operationally configured to promote further transfer of heat 114 away from the substrate 106 toward the heat sink 105 and out through the one or more apertures 111 while simultaneously promoting air flow 115 that effectively cools the substrate 106 and corresponding array 108. As a result of employing a non-planar substrate 106 and heat sink apertures 111, the heat sink 105 requirements of the present light assembly 100 are reduced in comparison to similar LED arrays mounted to planar substrates. For example, with reference to the light assembly 100 as shown in FIGS. 10-23, a suitable heat sink 105 may be constructed from aluminum at a weight of about 0.91 kg or less (about 2.0 pounds or less).

As stated above, the lense 110 may be operationally configured to protect the LED array 108 of the assembly 100 and enhance light output of the assembly 100. Like the housing base 102, the lense 110 is suitably constructed from materials including, but not necessarily limited to those materials resistant to chipping, cracking, excessive bending and reshaping as a result of ozone, weathering, heat, moisture, other outside mechanical and chemical influences, physical impacts, and combinations thereof.

In one regard, the lense 110 may be provided for purely decorative or aesthetic purposes. Thus, the shape and color of the lense 110 may be altered as desired. In addition, the lense 110 may be constructed of one or more materials and include optical properties effective to enhance the light output of the light assembly 100. The lense 110 may further include UV light resistant materials. Suitable lense 110 materials include, but are not necessarily limited to glass, plastics including but not necessarily limited to acrylics, polycarbonates, and other synthetic polymers. In one embodiment, the lense 110 may be transparent or translucent. In another embodiment, the lense 110 may include a filter or include one or more colors effective for filtering light as desired.

The invention will be better understood with reference to the following non-limiting example, which is illustrative only and not intended to limit the present invention to a particular embodiment.

### Example 1

In a first non-limiting example, a light assembly 100 as depicted in FIGS. 10-23 is provided.

### Example 2

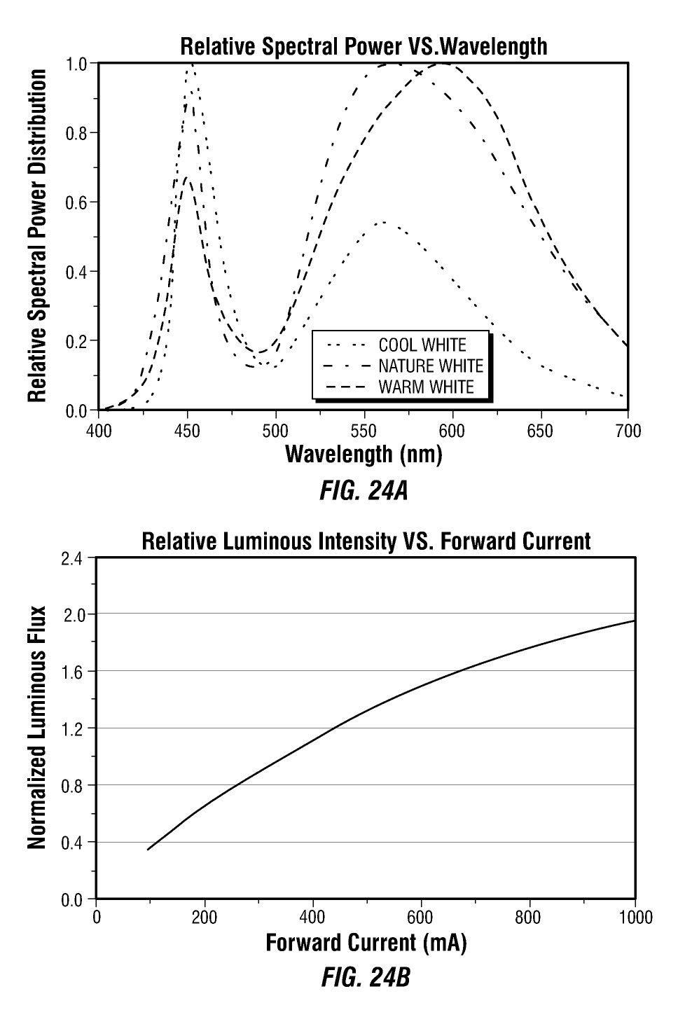

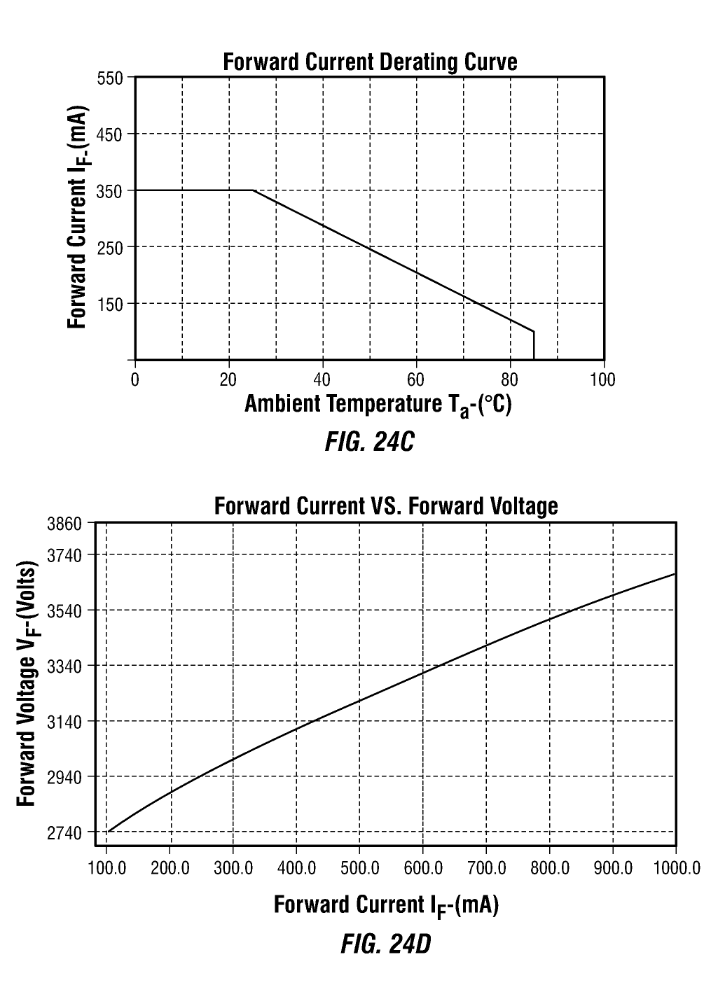

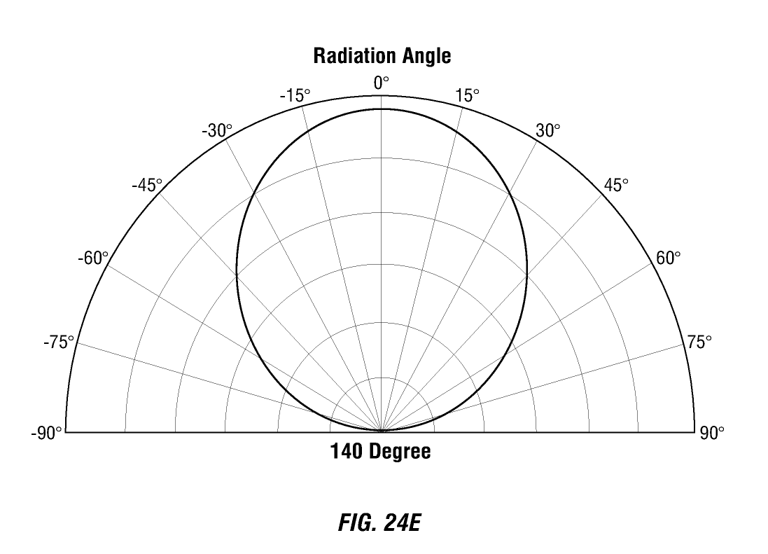

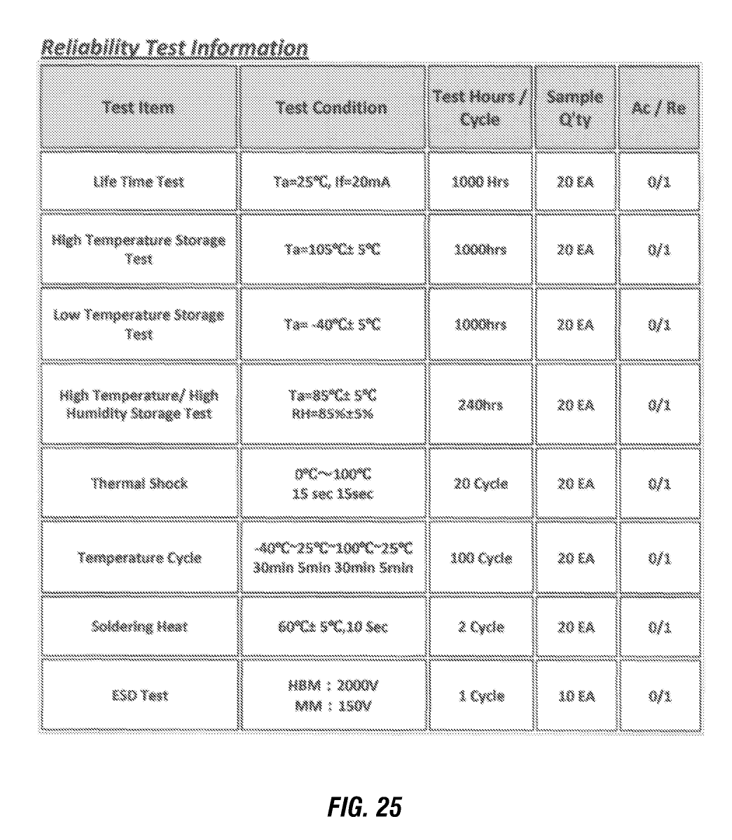

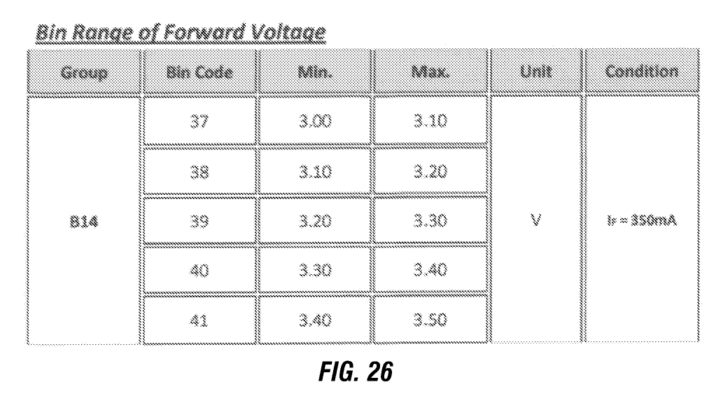

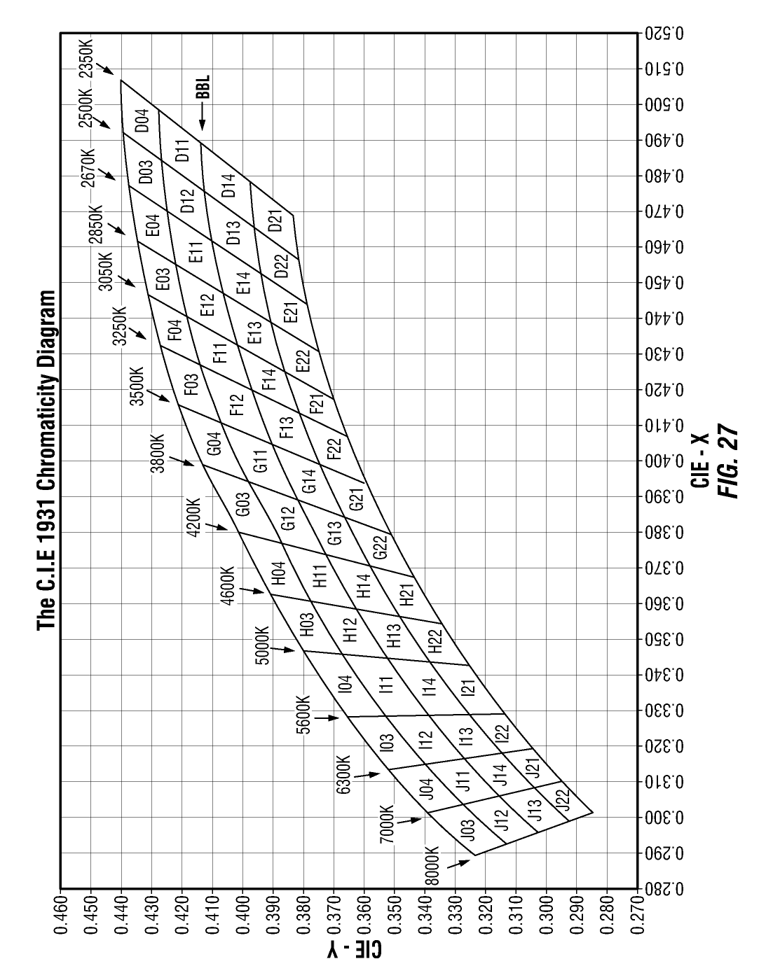

In a second non-limiting example, a light assembly 100 as depicted in FIGS. 10-23 was assembled and operated for a pre-determined period of time. Various data was gathered during operation of the light assembly 100 as depicted in FIGS. 24-27.

Persons of ordinary skill in the art will recognize that many modifications may be made to the present application without departing from the spirit and scope of the application. The embodiment(s) described herein are meant to be illustrative only and should not be taken as limiting the invention, which is further discussed in the paragraphs below.

A light assembly comprising: an outer housing; a power source; a heat sink disposed within the outer housing; and a non-planar substrate joined to the heat sink and operationally configured to accommodate one or more LED thereon.

The light assembly of the previous paragraph wherein the outer housing includes a base and a lense operationally configured to seal the power source, heat sink, substrate and accompanying LED array there between.

A light assembly comprising: a base including a heat sink and a power source; and a substrate having a non-planar surface attached to the heat sink, the shape of the substrate providing a space between the substrate and heat sink; wherein the substrate is operationally configured to receive one or more LED thereon; and wherein heat generated by the one or more LED is transferred away from the substrate toward the heat sink via said space there between.

The light assembly of the previous paragraph wherein the substrate includes a convex outer surface for receiving LED thereon.

A light assembly for illuminating light via an array of LED, the assembly comprising: a non-planar substrate, whereby the array of LED are mounted to the outer surface of the substrate in a manner effective whereby light emitted from each LED is directed along a non-parallel relationship in relation to light being emitted from the remaining LED of the array.

A light assembly for illuminating light via an array of LED, the assembly comprising: a non-planar substrate, whereby the array of LED are mounted to the outer surface of the substrate in a manner effective whereby light emitted from each individual LED is directed along a directional path substantially perpendicular to the plane of the tangent line located at the point of attachment of each LED to the non-planar substrate.

A method of increasing light spread as emitted from a light source comprised of a plurality of LED, the method comprising: providing a light assembly having (1) an outer housing; (2) a power source; (3) a heat sink disposed within the outer housing; and (4) a non-planar substrate joined to the heat sink and operationally configured to accommodate one or more LED thereon. A method of dissipating heat from a light source comprised of a plurality of LED, the method comprising: providing a light assembly having (1) an outer housing; (2) a power source; (3) a heat sink disposed within the outer housing, the heat sink having one or more apertures there through; and (4) a nonplanar substrate joined to the heat sink and operationally configured to accommodate one or more LED thereon.

1. A light assembly comprising:
an outer housing;
a power source;
a heat sink disposed within the outer housing; and
a non-planar substrate joined to the heat sink and operationally configured to accommodate one or more LED thereon.

2. The light assembly of claim 1 wherein the outer housing includes a base and a lense operationally configured to seal the power source, heat sink, substrate and accompanying LED array there between.

3. The light assembly of claim 2 wherein the substrate includes a convex outer surface for receiving LED thereon.

4. The light assembly of claim 3 wherein said one or more LED is positioned on a meridian of the convex outer surface.

5. A light assembly comprising:
a housing;
a power driver attached to said housing;
a heat sink releasably attached to said housing;
a nonplanar substrate having one or more LED disposed thereon, wherein said substrate is releasably attachable to said heat sink;
said one or more LED being in electrical communication with said power driver.

6. The light assembly of claim 5 wherein said power driver, heat sink, and one or more LED lie in electrical communication by passing electrical one or more pin of said power driver through an aperature(s) in said heat sink and making an electrical connection to said ore or more LED.

7. The light assembly of claim 5 wherein heat generated by the one or more LED is transferred away from the substrate toward the heat sink via said space there between.

8. The light assembly of claim 5 wherein the substrate includes a convex outer surface for receiving said one or more LED thereon.

9. The light assembly of claim 8 wherein said one or more LED is positioned on a first meridian of the convex outer surface

10. The light assembly of claim 9 wherein said one or more LED includes first and second LEDs and wherein said first LED is on the first meridian and said second LED is positioned on a second meridian of the convex outer surface.

11. The light assembly of claim 9 wherein said first and second meridians intersect.

12. A method of dissipating heat from a light source comprised of a plurality of LED, the method comprising:
providing a light assembly having
(1) an outer housing,
(2) a power source,
(3) a heat sink disposed within the outer housing, the heat sink having one or more apertures there through, and
(4) a nonplanar substrate joined to the heat sink and operationally configured to accommodate one or more LED thereon.
